(19) United States
(12) Patent Application Publication
(10) Pub. No.: US 2025/0008293 A1
(43) Pub. Date: Jan. 2, 2025

(54) METHOD AND SYSTEM OF SOUND LOCALIZATION USING BINAURAL AUDIO CAPTURE

(71) Applicant: Intel Corporation, Santa Clara, CA (US)

(72) Inventors: Hector Cordourier Maruri, Guadalajara (MX); Jesus Rodrigo Ferrer Romero, Zapopan (MX); Diego Mauricio Cortes Hernandez, Hillsboro, OR (US); Rosa Jacqueline Sanchez Mesa, Zapopan (MX); Sandra Coello Chavarin, Zapopan (MX); Margarita Jauregui Franco, Zapopan (MX); Willem Beltman, West Linn, OR (US); Valeria Cortez Gutierrez, San Luis Potosi (MX)

(73) Assignee: Intel Corporation, Santa Clara, CA (US)

(21) Appl. No.: 18/214,884

(22) Filed: Jun. 27, 2023

(51) Int. Cl. H04S 7/00; G06N 3/0464

(52) U.S. Cl. CPC H04S 7/40; G06N 3/0464; H04S 2400/11

(57) ABSTRACT

A system, article, device, apparatus, and method of audio processing comprises receiving, by processor circuitry, binaural audio signals at least overlapping at a same time and of a same two or more audio sources. The method also comprises generating localization map data indicating locations of the two or more audio sources relative to microphones providing the binaural audio signals and comprising inputting at least one version of the binaural audio signals into at least one neural network (NN).

### BACKGROUND

In many smart environments, the spatial location of an audio source (determined by audio source detection) can be important. For example, knowledge of the location of an audio source can be used to identify if sound is being emitted from a particular audio source, including a person speaking or other sounds, and for many different applications such as augmented reality (AR), speech recognition (ASR) and particularly hearing impaired assistance, speaker recognition (SR), audio event detection such as for security or surveillance, or even vehicle collision avoidance. Otherwise, automatic localization is used to determine if an audio source is causing interference with other sounds, or is used for context awareness to detect the environment around the audio source often to be used for audio enhancement as well as other purposes.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an audio processing system with binaural microphones providing localization map data according to at least one of the implementations disclosed herein;

FIG. 2A is a schematic diagram of a perspective side and front view of a user wearing binaural microphones according to at least one of the implementations disclosed herein;

FIG. 2B is a schematic diagram of a top view of a user wearing binaural microphones according to at least one of the implementations disclosed herein;

FIG. 3 is a flow chart of an example method of audio processing for generating localization map data according to at least one of the implementations disclosed herein;

FIG. 4 is a schematic flow diagram to explain generation of a localization map from 3D locations according to at least one of the implementations disclosed herein;

FIG. 5 is a schematic diagram of a localization map generation neural network according to at least one of the implementations disclosed herein;

FIGS. 6A-6C are images of audio sources emitting audio according to at least one of the implementations disclosed herein;

FIGS. 6D-6F are images of localization maps superimposed over the images of FIGS. 6A-6C according to at least one of the implementations disclosed herein;

FIG. 7 is a schematic diagram of an audio source position map used for the training of a localization map generation neural network according to at least one of the implementations disclosed herein;

FIG. 7A is a coordinate axis diagram for orientation of directions on FIG. 7;

FIG. 8 is a schematic diagram of a training setup for training and testing a localization map generation neural network according to at least one of the implementations disclosed herein;

FIG. 9A is a collection of images of ground truth localization maps for the testing of FIG. 8A and according to at least one of the implementations disclosed herein;

FIG. 9B is a collection of images of resulting predicted localization maps generated by a neural network and corresponding to the ground truth localization maps of FIG. 9A according to at least one of the implementations disclosed herein;

FIG. 10 is an illustrative diagram of an example system;

FIG. 11 is an illustrative diagram of another example system; and

FIG. 12 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes unless the context mentions specific structure. For instance, various architectures employing, for example, multiple integrated circuit (IC) chips and/or packages, and/or various computing devices and/or consumer electronic (CE) devices such as laptop, desktop, or other personal (PC) computers, tablets, mobile devices such as smart phones, smart speakers, or smart microphones, conference table microphone(s), video game panels or consoles, high definition audio systems, surround sound or neural surround home theatres, television set top boxes, and so forth as long as such devices can provide a localization map by using binaural audio signals, or is a binaural audio input or recording device, such as headphones, headsets, hearing aids, earbuds, glasses with microphones, or other binaural devices, may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

As used in the description and the claims, the singular forms “a”, “an” and “the” are intended to include the plural forms as well, unless the context clearly indicates otherwise. It also will be understood that the term “and/or” as used herein refers to and encompasses any and all possible combinations of one or more of the associated listed items.

Systems, articles, devices, and methods of sound localization with binaural audio capture.

A number of conventional techniques may be used to detect the location of audio sources. One such technique is the use of optical sensors to detect the visual location of the object and make assumptions, or perform further processing, to identify an object as an audio source. Specifically, and with many smart device systems, objects of interest that produce sound can be detected with the help of one or more optical sensors, such as cameras, infra-red (IR) sensors, light detection and ranging (LIDAR), and so forth. For voice detection, some video processing algorithms can detect lip movement to determine if a person is actively speaking. These solutions, however, often require high quality imaging and in turn, extra hardware circuitry and expensive cameras such as HD cameras. Although less expensive cameras can be used, such cameras often sacrifice resolution quality. The optical devices also use a relatively large number of operations, particularly due to the additional processing to determine whether or not a detected object is actually an audio source, thereby consuming large amounts of processor time and power. Finally, these optical routines will not detect sounds that don't produce an image cue.

Another optical device is referred to as an acoustic camera. The acoustic camera is usually placed in the middle of a circular disc or sphere of large microphone arrays, such as 30+ individual microphones, and has function specific hardware and software to superimpose audio signal amplitude measurements of an environment onto camera images to detect the audio sources in real time. The acoustic cameras, however, are delicate and extremely expensive so that their use is usually limited to acoustic laboratories.

Otherwise, in another known technique, large microphone arrays detect the time difference of arrival (TDOA) of each audio signal from the individual microphones, and fast Fourier transform (FFT) and deep learning (DL) algorithms may be used for cross-correlation to detect audio or sound sources. Such large mic array systems, however, have a relatively large computing overhead, and is usually performed by dedicated digital signal processor (DSP) modules that consume a large amount of power. Usually, a compromise is made between the number of microphones in the array and the complexity or precision of the location detection algorithm thereby often sacrificing accuracy. Also, the number of microphones to detect an audio signal in all directions, as well as the required processing capacity and power consumption, may be impractical on small, wearable audio source or listening devices.

While some of the these acoustical and optical audio source detection techniques mentioned above can detect simultaneous multiple audio sources, this is usually at the expense of a large increase in computational complexity of the detection algorithms.

Some known binaural input audio source detection systems use deep learning algorithms. Such known binaural input audio systems, however, merely detect a single audio source at a time and have overly large computational loads.

To resolve the issues mentioned above, the method, devices, and system described herein may generate localization map data by inputting binaural audio signals into a localization map data generation neural network to detect the location, and particularly the direction or angle of arrival (AoA), of one or multiple simultaneous audio sources, and relative to a position of a person wearing a binaural device. The localization map data may be used to form a localization map (or amplitude heat map or spherical audio amplitude heat map) such as a 2D heat map for example that indicates the audio source positions at hot spots on the map. Many different audio processing applications then can use the localization map data. It will be understood that the localization map data output from the neural network may be used directly without generating a visual map for display, and depending on the needs of the audio processing application using the localization map data.

Specifically, the present system takes advantage of the binaural nature of the human ears. The distance from an audio source is slightly different from ear to ear and the physical features of the human head itself as well as the shape of the pinna (exterior portion of the ear) causes differences in the acoustic characteristics of the acoustic waves received by the ears, and particularly volume levels and frequency content, such as high frequencies. Thus, in effect, the head and ears filter out certain audio frequency content in certain directions (or AoAs) from the ears, but the effect is different depending on the angle or direction. This permits the human brain to determine any direction or AoA of audio by using these frequency content differences, to correctly estimate sound location from 360 degrees (or in other words, from a sphere of directions around the head).

When recordings are made in a similar fashion by placing microphones sufficiently close to a person's ears so that a person's ear shape and head will affect the audio signals, this is referred to as binaural recordings from a binaural device. Such devices may be any such head-worn device with microphones near the ears such as headphones, headsets, ear pods, and even glasses with microphones, including smart glasses.

To perform the localization map data generation, the binaurally captured audio is turned into binaural audio signals that then can be provided to a localization map generation unit or device. The localization map generation is then performed by inputting versions of the binaural audio signals into a deep learning regression neural network that is trained to be analogous to the human mind receiving binaural audio signals from the human ears. By one form, at least one neural network, which here is considered a single neural network, has a time domain encoder using convolutional encoder blocks, and a frequency domain encoder that uses fully connected layers. The outputs of the two encoders are combined to form input for a decoder also using fully connected layers. The neural network generates localization map data, which can be data for a 2D heat map of sound amplitude, and to identify the location of audio sources ideally in a full spherical environment around a person's head wearing the binaural audio device. This enables all-direction sound or audio source detection with a mere two microphones.

The generation of the localization map can show multiple audio source location “spots” or “hot spots” at the same time to permit multiple simultaneous sound source detection. Since the present solution herein may be based on a mere two microphones on head-worn gear (or a binaural device) and by using a relatively simple DNN, this provides the locations of multiple sound sources in all directions without using complex algorithms with large computational loads and power consumption.

More specifically, in a full system implementation, the present method and system successfully detects audio all around a spherical environment (or audio from any direction) of the user's head, and with a performance of about 100 mean angle error detection (or in other words, high performance with high resolution levels of about 10° granularity).

By one example, head-worn sound spatial location also can be performed by using smart glasses to provide sound localization to assist the hearing impaired. Such systems can show subtitles on a screen on the lens of the glasses and in front of a person speaking for example.

By one form, the localization map data, and map images when desired, may be generated remotely at a cloud-based processing service for example so that such computational load, power consumption, and accompanying function specific hardware need not be located on small mobile devices performing audio processing with the resulting localization map data.

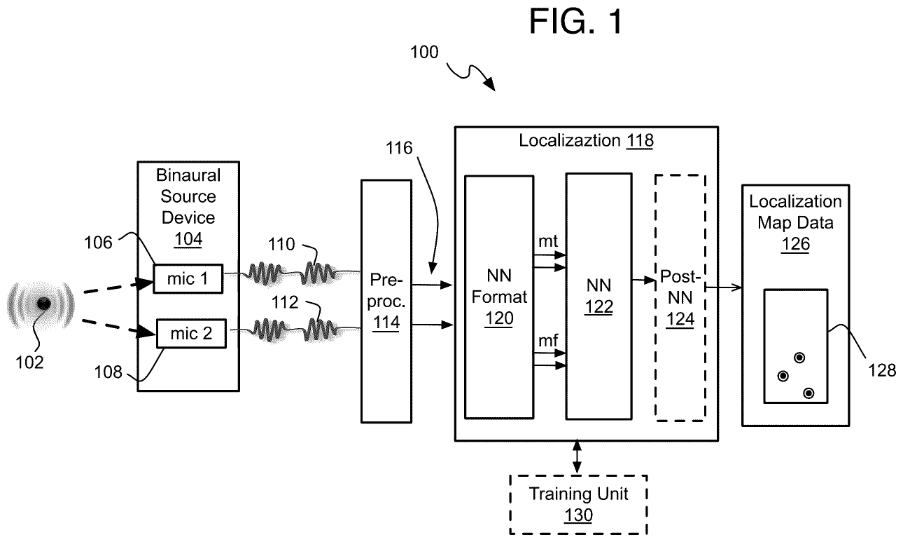

Referring to FIG. 1, an example audio processing system 100 has a binaural audio source (or pick-up) device or input device 104 with two binaural microphones 1 (106) and 2 (108) that receives acoustic waves from at least one audio source 102. By one example, the number and type of audio sources 102 is not particularly limited and may be one or more people speaking, music, or any other one or more audio events or sounds. The audio source 102 may be in any direction and distance from the microphones 106 and 108 to emit acoustic waves into the air within a pickup range of the microphones 106 and 108.

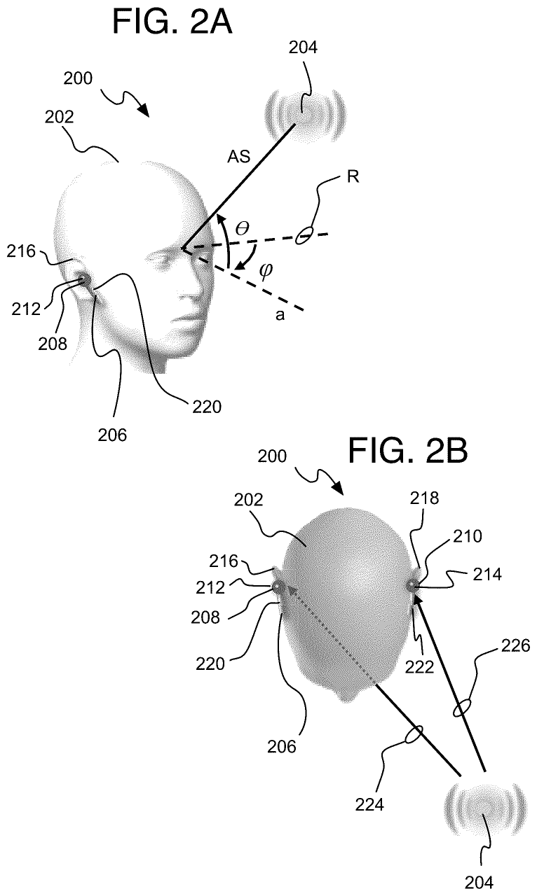

Referring to FIGS. 2A and 2B, the microphones 106 and 108 may be any microphones of any binaural device 104 including a headphone, a headset, earbuds, glasses, and so forth as long as the microphones can be held near the ears, and by one form within at most about or exactly thee inches from the ear, or within two inches from the ear, and by one example, including within, adjacent, or at the opening of the ear canal (or external acoustic meatus), as with earbuds. For example, a user's head 202 is within a pickup range of an audio source 204. The user may be wearing a binaural audio source or listening (or input) device 206 such as a pair of earbuds, with right earbud 208 and left earbud 210 each respectively having a microphone 212 and 214 within the ear canal or at the entrance of the ear canal respectively of ears 216 and 218. Note the earbuds 208 and 210 also may have stems 220 and 222 with additional microphones that are not used, or may be used instead or in addition to microphones at the buds of the earbuds 208 and 210. As shown, the audio source 204 may be in a linear AS direction or AoA from the head 202, and in turn from binaural microphones 212 and 214, which may be defined or represented by an azimuth or horizontal angle φ from a horizontal reference line R to an azimuth direction a, and by a vertical or elevational angle θ to the azimuth direction a (or a plane formed by the azimuth direction a and the reference line R). Thus, the position or direction of the audio source 204 from the user's head 202, and in turn the binaural microphones 212 and 214, may be designated with coordinates (φ, θ). The top view of the user's head 202 of FIG. 2B shows the different distances 224 and 226 from the audio source 204 and to the ears 216 and 218 that generate the binaural acoustic waves.

Also, the binaural microphones 212 and 214 should have a directional sensitivity pattern, which often depends on the arrangement of the microphone's enclosure, the acoustic openings and shape of a microphone housing, and other microphone characteristics. An example directional sensitivity pattern is often a cardioid type of pattern with a main direction that is outward from the ears and to the sides (e.g., laterally) and slightly forward (or anteriorly) from the ears to imitate the sensitivity pattern of the human auditory system. Thus, if straight forward is a 0 degree azimuth, the sensitivity pattern should be a cardioid type of pattern with a main direction towards about 60-75 degrees horizontally, and straight forward vertically.

Returning to FIG. 1, and by some examples, the binaural source device (or just input device) 104 to be used during a run time to capture binaural audio signals may be the head-worn device itself such as the headphones, earbuds, and so forth and that have the circuitry and transmitter to transmit or otherwise provide audio signals 110 and 112 whether or not the head-worn device is coupled or paired to another base device. By other examples, the head-worn device is the microphones 106 and 108 and are considered peripherals, and the input device 104 is a base device, which may be any computing device that can be wirelessly paired or attached by wires to the head-worn device such as a desktop computer, extension monitor with mics, laptop, notebook, tablet, smartphone, or any smart or computing device that receives the audio signals from the microphones 106 and 108 before performing the localization map data generation at the device 104 or transmitting the audio signals to another device that performs the localization map data generation, such as a server or other computing device.

The system 100 also may have a pre-processing unit 114, a localization unit 118, and a localization map data unit 126. By one example as suggested above, the pre-processing unit 114 and a localization unit 118 that performs the localization map data generation are both part of input device 104, whether circuitry for the map data generation is provided on smart headphones or on a laptop for example. Otherwise, the localization unit 118 may be on a remote server, cloud server, website, network, and so forth, or other remote computing device that is remote from the input device 104.

By one form, the audio signals 106 and 108 may be constructed by using a sampling rate, with or without overlap, such as 44.1 kHz but could be as low as 32 kHz or up to 48 kHz or more. Then, the binaural audio signals 110 and 112 either may be provided as raw audio signals with no pre-processing or may be modified by pre-processing. The pre-processing may be performed by the pre-processing unit 114 or the input device 104 itself. This may include performing pre-processing such as analog-to-digital (ADC) conversion, acoustic echo cancellation (AEC), denoising, dereverberation, amplification, automatic gain control (AGC), beamforming, dynamic range compression, and/or equalization to provide a cleaner, more desirable binaural audio signal. By one form, equalization is performed when the binaural input device 104 does not locate the microphones 106 and 108 within or at the ear canal, such as with large cup headphones that may have the microphones 1-3 inches away from each ear. In this case, an equalizer 115 may adjust or filter the frequencies of the audio signals to be more similar or the same to frequencies from audio signals of microphones at, adjacent, or within the ear canal.

Some of these pre-processing techniques, such as ADC, should be performed to obtain audio signals in an expected condition for the localization map data generation neural network. In some cases, however, such initial denoising and other microphone or device specific pre-processing could provide unexpected audio signal data to the neural network that results in inaccurate localization data. In these cases, the system will not work when no way exists to automatically or manually disable the extra undesirable pre-processing. It will be understood that such an option to automatically or manually disable pre-processing techniques may be available.

Also, it should be mentioned that by definition, the binaural audio signals 110 and 112 are synchronized to maintain an interaural difference established upon the capture of the audio, and whether it varies or is fixed. Such maintaining of the interaural difference synchronization may be performed by the head-worn device 104 with the binaural microphones 106 and 108 or a device with the microphones 106 and 108 that is paired or coupled to a base device 104 that provides the binaural audio signals 110 and 112.

The pre-processing also may include any compression and decompression when the audio signals 110 and 112 are to be transmitted through wires and/or wirelessly to the localization unit 118, and whether through internal circuitry, or personal, local area, telecommunications, or wide area networks.

The now pre-processed audio signals 116 then may be provided to the localization unit 118, and by one particular example, by being placed in one or more NN buffers. A NN format unit 120 then may modify the audio signals 116 to construct the audio signal inputs to be input into a localization map data generation neural network also referred to as a regression neural network or (or just NN) 122. This may include collecting the binaural audio signal samples into frames (or blocks of data) expected by the NN 122. For one example, say about 16,384 samples may be collected to form a single time domain frame of about 0.371 seconds. For the time domain, each frame of each binaural audio signal is an input vector of the sample values for a particular frame time (or time period or time stamp). Two channels (right and left) are input into the NN 122 one after another that is of the same frame time. The two time domain binaural channels mt are then input to the NN 122 consecutively frame time after frame time, although some desired interval may be used instead.

The NN format unit 120 also then may generate frequency domain frames (or frequency vectors) by applying feature extraction, such as fast Fourier transform (FFT), to generate frequency domain (or spectrum) values of each frequency frame. By one form, the frequency vectors also are each one frame, and one vector is provided for each of two binaural right and left channels. The length of the frequency vector is a number of frequency or spectrum bins, and in turn frequency values. By one example form, 8192 frequency bins per frequency frame are used, which is half the number of samples of the time domain frames, and for the reasons explained below. The binaural pairs of frequency vectors form two channels mf both of the same time frame, and are input to the NN 122 time frame after time frame as well. The details of the FFT conversion to the frequency domain are explained below.

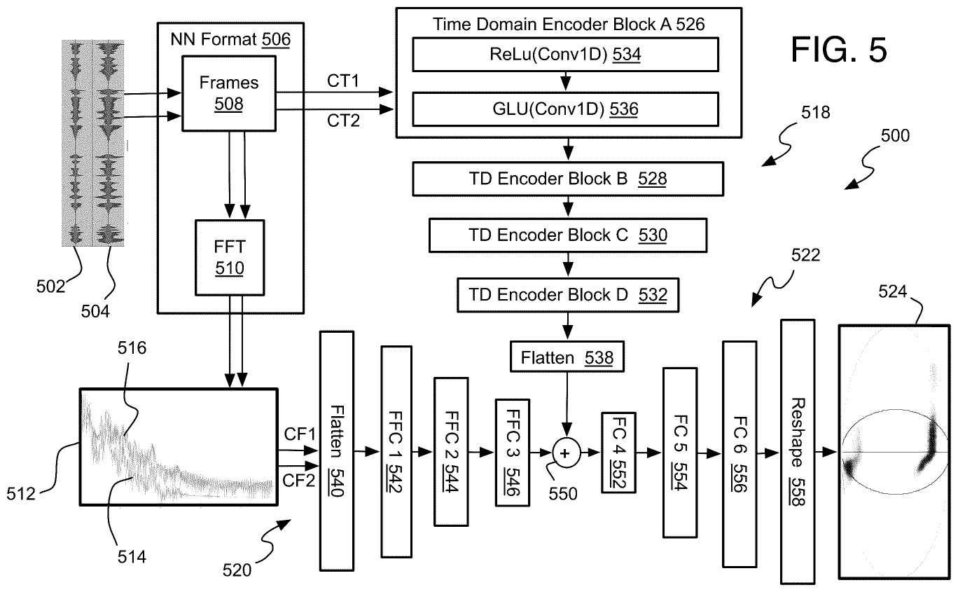

The same time frame of the time domain and frequency domain vectors are then input to the NN 122, and respectively to time domain and frequency domain encoders. The time domain encoder may include convolutional encoder blocks, and the frequency domain encoder may include a series of fully connected layers. The output of both encoders is combined and input into a decoder with fully connected layers to output amplitude values for pixel locations of a localization map. The details of the NN 122 are the same or similar to that of NN 500 (FIG. 5) described below.

Hardware used to operate the NN 122 may include accelerator hardware such as one or more specific function accelerators with one or more multiply-accumulate circuits (MACs) to receive the NN input and additional processing circuitry for other NN operations. By one form, either the accelerator is shared in a context-switching manner, or one or more accelerators may have parallel hardware to perform localization map data generation to different sections of a frame or different frame time periods in parallel. An output buffer (not shown) may be provided to collect the amplitude values.

Optionally, a post-NN unit 124 also may perform any post-processing on the output localization map data when desired. This may include normalization of the amplitude values if the amplitude values are not already output in a range of 0 to 1. The amplitude values per pixel location then may be provided directly to other applications for further audio processing using audio source locations.

Otherwise, amplitude values may be provided to the localization map data unit 126 to generate image values, whether or not an image of a localization map is to be displayed. In one example, the localization map data unit 126 converts the amplitude values to one in a range of color values when the localization map is to be a heat map 128 for example. The assignment of colors to values within the amplitude range, such as 0 to 1, can be any color (including gray scale) scheme that is desired. The color values, or in other words a localization or heat map image, then may be provided for further audio processing and/or display.

Whether the amplitude values are being provided directly from the localization unit 118, or a localization map is being provided from the localization map data unit 126, such data may be transmitted to remote output devices, and such transmission may be through a communications or computer network. This network may be a wide area network (WAN), telecommunication network, local area network (LAN), or even a personal area network (PAN). The network may be, or include, the internet, and may be a wired network, wireless network, or a combination of both. By one example form, such a network is a device-to-device (D2D) direct interconnect network.

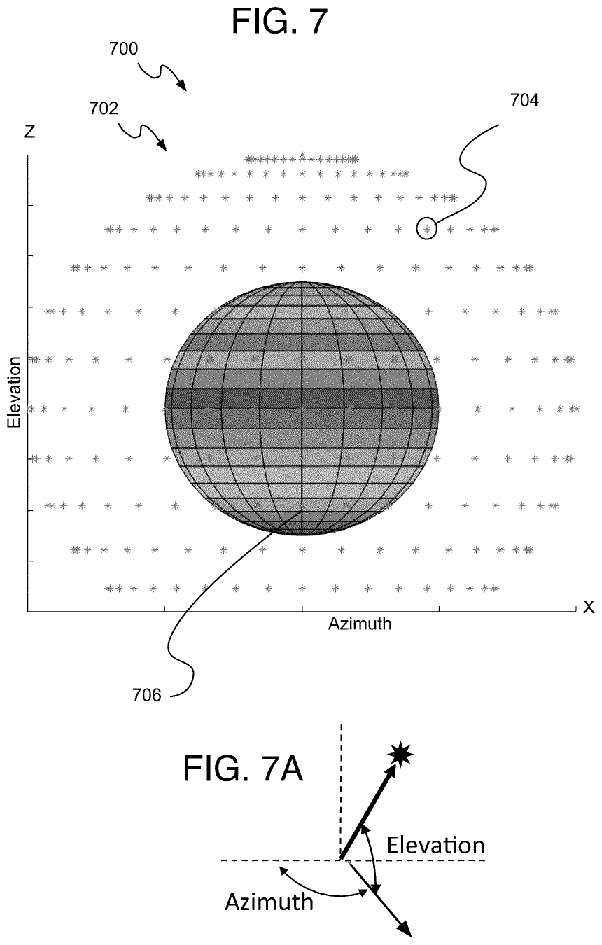

By one form, the system 100 also optionally may have a training unit 130 that performs training tasks to train NN 122 and on the same device as the localization unit 118 or another separate device. Such training is described below with FIGS. 7-9B.

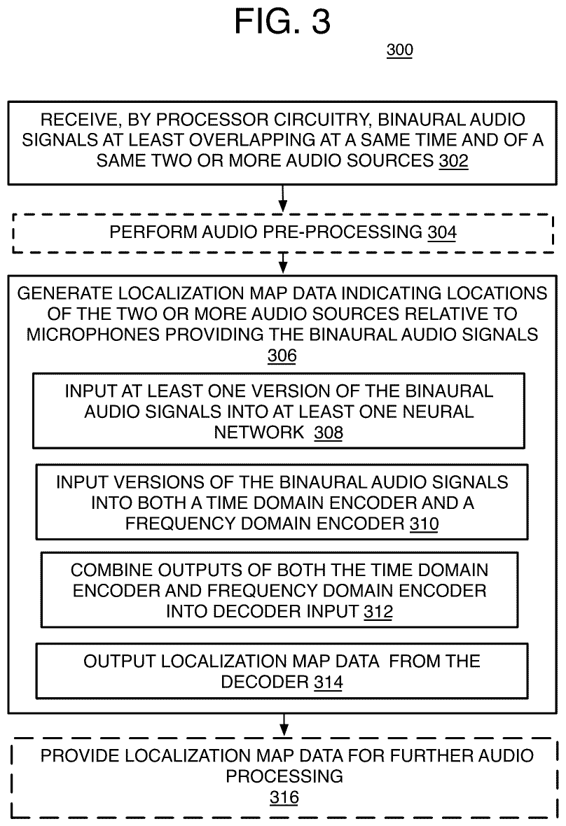

Referring to FIG. 3, an example process 300 for sound localization map data generation using binaural audio capture is provided. In the illustrated implementation, process 300 may include one or more operations, functions, or actions as illustrated by one or more of operations 302 to 316 generally numbered evenly. By way of non-limiting example, process 300 may be described herein with reference to example systems 100, 200, 400, 800, 1000, 1100 and 1200, and neural network 500 described herein with FIGS. 1, 2, 4, 5, 8, and 10-12, or any of the other systems, devices, processes, environments, or networks described herein, and where relevant.

Process 300 may include “receive, by processor circuitry, binaural audio signals at least overlapping at a same time and of a same one or more audio sources” 302. This may include many different types of audio environments and audio sources that emit audio captured by a binaural audio input or source (or listening) device as described above. The binaural audio input device may be any of many different head-worn devices that place a binaural microphone near each ear, and by one form within at most 3 inches from the ear canal.

This operation 302 also may include receiving audio signals associated with audio emitted from multiple audio sources at the same time. Same time here may refer to a single time point or a time period, and may be determined by a time stamp of samples or frames of the captured audio signals for example. It also should not matter how many audio sources are present.

The device receiving the audio signals to perform localization map data generation may be the same device with the microphones or may be a different device remotely coupled to the device with the microphones as described above with system 100. By one form, any computing device with sufficient capacity may be used to perform localization map data generation. Also, the device performing the localization map data generation may operate during a run-time and live (or real time) and as the binaural audio signals are being streamed. Alternatively, or additionally, such a localization map data generation device and NN may analyze pre-recorded binaural audio signals.

This operation 302 also may include capturing samples at a sample capture rate that is expected by the localization unit or neural network. By one example, the sampling rate is 44.1 kHz, but as low as 32 kHz and as high as 48 kHz or more, although other sampling rates can be used instead.

Process 300 optionally may include “perform audio pre-processing” 304, and this may include any of the pre-processing techniques described above with pre-processing unit 114 and when desired to begin preparing the audio signals to be modified for the neural network. The pre-processing may include denoising, and so forth, as listed above, and may include equalization when the binaural microphones are in the vicinity of the ear canal but are not within or adjacent the ear canal.

Process 300 may include “generate localization map data indicating locations of the two or more audio sources relative to microphones providing the binaural audio signals” 306, and specifically by having a regression neural network (NN) to generate localization map data during a run-time (or live or in real-time). This operation 306 may include “input at least one version of binaural audio signals into at least one neural network” 308, and by one form, specifically to “input versions of the binaural audio signals into both a time domain encoder and a frequency domain encoder” 310. Thus, by one example form, the multiple audio signals may be converted into time domain frames, and the time domain frames then may be converted into frequency domain frames. The frequency domain frames and the domain frames each may be a 1D vector and in pairs for both binaural audio channels that are input into the frequency domain and time domain encoders of the example neural network.

Thereafter, operation 306 includes “combine outputs of both the time domain encoder and frequency domain encoder into domain decoder input” 312. By one form, the time domain encoder has a series of encoder blocks, and the time domain vectors of the two binaural channels and of the same frame time are input into the first encoder block. By one example detailed below, one or more of the encoder blocks use two convolution layers, a gated linear unit (GLU) layer, and a rectified linear unit (ReLU) layer. The order of the layers is described below with a NN 500 (FIG. 5). The last encoder block outputs channels each with a vector of samples. A flattening layer then may be used to combine all of the channels into a single vector with a number of elements that corresponds to nodes of an input layer of the decoder.

Likewise, the frequency domain encoder has a flattening layer at the input side of the encoder and combines the two frequency vectors of the two binaural channels into a single vector to be input into a series of the frequency fully connected layers. The output vector of the least frequency fully connected layer is concatenated with the output vector from the time domain flattening layer to form a single input vector input to the decoder.

The decoder provides a generally mirrored layer structure compared to that of the frequency domain encode. The decoder has a series of decoder fully connected layers that provide a vector of elements to a reshaping layer that converts the vector into amplitude values each with 2D coordinates, and as assigned to certain output nodes of an output layer (or the reshaping layer).

The operation 306 then provides “output localization map data from the decoder” 314. Thus, the decoder outputs the amplitude values, each assigned 2D coordinates of a localization map, and as the localization map data.

Process 300 then may include “provide the localization map data for further audio processing” 316. Here, the localization map data output from the NN may be in the form of per pixel audio signal amplitude values, and for individual or all pixels of a 2D localization map such as a spherical audio amplitude map when all-directions can be analyzed by the NN. By one form, the amplitude values may be normalized to 0 to 1. With or without normalization, the amplitude values then may be converted into color, grey scale, or other values to form an image of the localization map when desired. Then, whichever version of the output of the NN is desired, whether output amplitude values, normalized values, or the localization map image with color scheme values, may be compressed, transmitted over a computer or communications network to a remote output device, and decompressed for further processing by other audio applications, such as ASR or environment type detection for context awareness, as one example. Many other applications are mentioned herein.

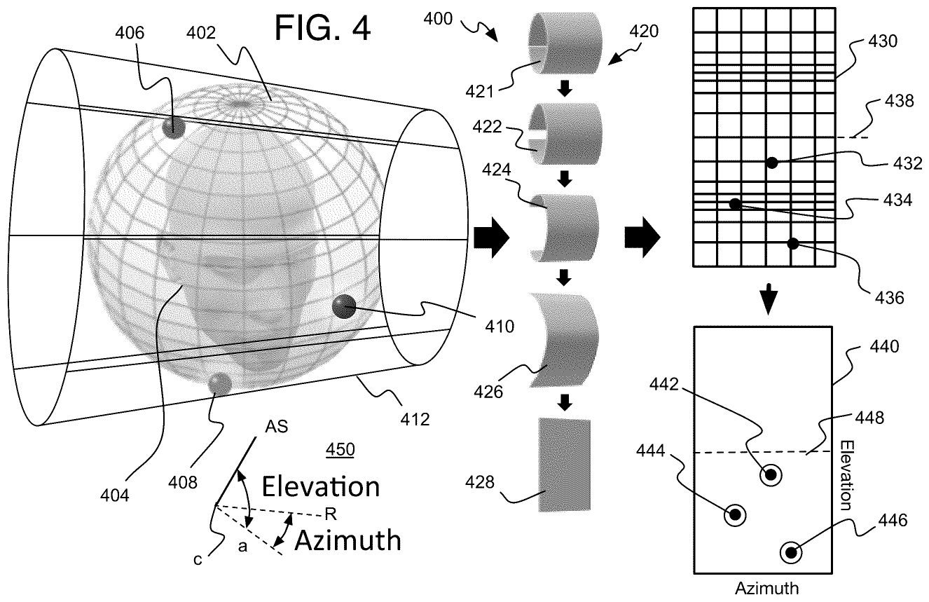

Referring to FIG. 4, a system 400 is shown to explain the generation and orientation of a localization map 440 as determined by the localization map data generation NN 122 described herein, and where the localization map may be a spherical audio amplitude heat map. Specifically, a person, or particularly a person's head, 404 may be considered to represent a person wearing binaural audio microphones (not shown here). A set of axes 450 is the same as that shown on FIG. 2A, and where an angle of arrival direction (AoA direction or AS) is shown on the axes 450. The convergence or intersection point of the axes c can be assumed to be at a center of the person's head 402 or another arbitrary fixed place on the person's head as shown on FIGS. 2A-2B for example. The head 404 is within a sphere 402 that represents the range of available directions of the AS extending toward the microphones (or the head 404), where a position (or average or generalized position) of the microphones is represented by the point c. Thus, the sphere 402 represents that the direction AS from one or more of the audio sources can be from any direction. The sphere 402 may be considered to have spherical coordinates on its surface that may be converted (inherently by the NN 122) into 2D coordinates of a 2D projection surface 430. Such coordinates may be considered to be projected to a cylindrical frame 412. Three random audio source positions 406, 408, and 410 are shown on the sphere to represent three different AS directions for this example, and to be mapped on the localization map 440. By this example then, the spherical coordinates of the audio source positions 406, 408, and 410 may be considered to be projected to the frame 412.

Then, by one example, the 2D projection surface 430 may be considered as an unrolling of the frame 412 as shown by an unrolling process 420. This includes a first cylindrical shape of frame 412, now being a cylinder 421, and increasingly unrolled shapes 422, 424, 426, until a flat 2D rectangular shape or surface 428 is reached and is the 2D projection surface 430. The projection points 406, 408, 410, are now shown respectively as positions 432, 434, 436 on the 2D surface 430, and may have 2D coordinates (x,y). It should be noted that the since the 2D surface 430 represents coordinates of the entire sphere 402, in this example the bottom and top edges of the 2D projection surface 430 represent the same point on the sphere 402, such as the bottom of the sphere 402, while the half-height level 438 of the 2D surface 430 represents the top of the sphere 402. In other words, the top half of the 2D surface 430 may represent a back side of the sphere, while the bottom half of the 2D surface 430 may represent a front side of the sphere. The resulting localization map 440 then may have the same coordinate arrangement where half-height level 448 (on the map) corresponds to the level 438, and in this example, projected positions 432, 434, 436 on the 2D surface 430 becomes audio source locations 442, 444, and 446 respectively on the localization map 440. It will be appreciated, however, that this is only one example coordinate arrangement, and many variations may be used instead.

The NN 122 may have audio signal amplitude values at output nodes each assigned to 2D coordinates of the 2D projection surface 430. As mentioned above, the amplitude values may or may not be normalized, and may be converted into a color or gray scale scheme when display of an image of the localization map 440 is desired, thereby completing the localization map 440. The colors of each set of coordinates (or pixels) are converted into a heat map color for example to reveal hot spots for each location of an audio source.

Referring now to FIG. 5, an example localization map data generation neural network 500 is a regression neural network that has two encoders and a single decoder to generate localization map data of a localization map 524. For example, the NN 500 may have an architecture with a convolutional 1D time domain encoder 518, a frequency domain encoder 520, and a decoder 522. The output from the time domain encoder 518 may be fed into a bottleneck, which here is an adder 550, of the frequency domain encoder 520 and the decoder 522. With this example structure, the example NN 500 uses two different versions of the binaural audio signals as input, one in the frequency domain and the other in the time domain. The layers of the decoder 522 mirror the layers of the frequency domain encoder 520.

Specifically with regard to the format of the input binaural audio signals, a NN format unit 506 may have a frames unit 508 to collect the binaural audio signal samples of binaural audio signals 502 and 504 into time domain frames and may provide the time domain frames to a FFT unit 510. The time domain frames each may be provided as a 1D vector and for each frame (or frame time, time period, or time stamp) with both binaural audio signals thereby providing two time domain input channels CT1 and CT2. Thus, each vector of a same channel (same right or left binaural microphone) is a frame of a different time (different start time, time period, or time stamp for example) so that the 1D vector can be input into the NN 500 as a sequence of consecutive frames (although other intervals could be used) and alternating between input of channels CT1 and CT2. As a result, each input channel CT1 and CT2 represents a continuous audio signal. The elements of the time domain 1D vectors of each channel CT1 or CT2 are each a sample of an audio signal magnitude (or amplitude) along the duration of the single frame. By one form, the time domain frames are each 0.371 seconds in duration, or up to 0.4-0.5 seconds, and by one example, includes 16,384 samples at 44.1 kHz. Thus, each input channel CT1 or CT2 is or has a 1D vector or frame, each with the 16,384 samples, which may be used with or without an overlap, and by one form, could be a 50% hop when desired. In this example, the 1D time domain vectors also may be grouped in a batchsize, such as for training, for a batch of 128 frames for example providing an example input size of (batchsize (for training), channels, samples), and by one example (128, 2, 16,384) forming an input time domain tensor, although input into the NN 500 is still a 1D vector at a time as described above. Many variations exist.

The frequency domain also may be described as input frequency domain tensors where the batch size (batchSize), used particularly during training, and is equal to the number of frames to be processed during a certain duration of multiple frames. By one example, the batch size may be 128 for the frequency domain as well. In the frequency domain, however, each sample is a frequency value of a different bin. Thus, the length of a 1D vector forming the frequency domain input for the NN 500 is a number of frequency bins, which equals the number of frequency or spectrum values in the frame. Thus, with the training batchsize, the frequency input dimensions are (batchsize (when training), channels, bins (or length)), which by one example may be (128, 2, 8,192). The input vector length does not need to be the same as the input vector length of the time domain, and in this example is half the length of the time domain vectors. With this structure, a 1D vector is input for each of two frequency channels CF1 and CF2, and this is repeated for each frame (or frame time, time period, or time stamp). The frequency vectors of the same frame time then may be input, and by one form, one at a time, to a flatten (or flattening) layer or unit 540 as described below.

The FFT unit 510 may provide frames of the same duration as the time domain frames, albeit of different lengths due to the spectrum symmetry. As mentioned in the current example, 8,192 bins or spectrum values are being provided for each vector, here shown as left and right spectrums 514 and 516 of a same frame time 512, and in turn for each frequency domain frame with one for each frequency channel CF1 and CF2. The frequency values may be converted into a dB scale for input to the NN as desired.

By one approach, the time domain encoder 518 may include a sequence of similar encoder blocks, which may be convolutional encoder blocks, such as time domain encoder blocks A 526, B 528, C 530, and D 532. The first encoder block 526 show the similar layers of individual or all of the encoder blocks. Table 1 below is a chart of the encoder block structure with layers (or layer groups) 534 and 536 in the time domain encoder blocks. The table 1 shows the dimensions in and out of a layer (or accompanying layer) in channels×samples, as well as the size of the kernel and stride when a filter is being used.

TABLE 1
TIME DOMAIN ENCODER

| | Dim. In | Dim. Out | Filter |
|---|---|---|---|
| Layer | (ch × samp) | (ch × samp) | Kernel/Stride |
| Enc Blck A | | | |
| Conv1 | 2 × 16,384 | 64 × 4,096 | 8/4 |
| ReLU | 64 × 4,096 | 64 × 4,096 | |
| Conv2 | 64 × 4,096 | 64 × 4,096 | 1/1 |
| GLU | 128 × 4,096 | 64 × 4,096 | |
| Enc Blk B | | | |
| Conv1 | 64 × 4,096 | 128 × 1,024 | 8/4 |
| ReLU | 128 × 1,024 | 128 × 1,024 | |
| Conv2 | 128 × 1,024 | 256 × 1,024 | 1/1 |
| GLU | 256 × 1,024 | 128 × 1,024 | |
| Enc Blk C | | | |
| Conv1 | 128 × 1,024 | 256 × 256 | 8/4 |
| ReLU | 256 × 256 | 256 × 256 | |
| Conv2 | 256 × 256 | 512 × 256 | 1/1 |
| GLU | 512 × 256 | 256 × 256 | |
| Enc Blk D | | | |
| Conv1 | 256 × 256 | 512 × 64 | 8/4 |
| ReLU | 512 × 64 | 512 × 64 | |
| Conv2 | 512 × 64 | 1,024 × 64 | 1/1 |
| GLU | 1,024 × 64 | 512 × 64 | |
| Flatten | 512 × 64 | 32,768 nodes | |

Through the sequence of encoder blocks, the number of channels is increased, while the number of output values or elements are decreased, thereby providing a compressed or encoded output.

The last layer of the time domain encoder 518, however, may be a flatten (or flattening) layer 538 that collects the sample vectors of multiple channels output from the last encoder block D into a 1D vector, and in this example being 512 channels×64 samples each vector=32,768 nodes in a single vector, which then may be a number of input elements that each may have a corresponding node (or neuron) at an input layer 552 of the decoder 522. It will be appreciated that the flatten layer 538 may or may not be considered part of the time domain encoder 518, or even the NN 500, and may be considered a separate unit, particularly when performed with different hardware than that performing the other NN computations. The flatten unit 538 may be an extraction tool that extracts values from the 2D output of the last encoder block D 532, whether from a memory or other location, and in a certain order to construct the 1D decoder input vector, whether as needed (just in time) or to store the vector in memory. Many variations are contemplated.

As to the frequency domain encoder 520, a flatten (or flattening) layer 540 first receives the frequency domain 1D frame vectors from the channels CF1 and CF2 before being input to subsequent fully connected layers forming the frequency domain encoder 520. The flatten layer 540 concatenates the two input binaural frames of the same frame time to form a single 1D frequency vector with elements each corresponding to a node (or neuron) of a first frequency fully connected (FFC) layer 542 of the frequency domain encoder 520. As with flatten layer 538, flatten layer 540 also may or may not be considered a layer or part of the NN 500, and performs similar or the same element (or here frequency sample) manipulation and storage to construct the single 1D vector.

Thereafter, the frequency domain encoder 520 may include three frequency fully connected (FFC) layers 542, 544, and 546 including the one already mentioned. A Table 2 shows the changes in the number of nodes, and in turn the number of values or elements, at each of the three FFC layers. The activation function for the FFC layers 542-546 may be ReLU although other activation functions may be used instead such as sigmoid, hyperbolic tangent, leakyReLU, and so forth.

TABLE 2
FREQUENCY DOMAIN ENCODER

| | Dim. In | Dim. Out |
|---|---|---|
| Layer | (nodes) | (nodes) |
| Flatten | 2 × 8,192 freq. | 16,384 |
| FFC 1 | 16,384 | 128 |
| FFC 2 | 128 | 256 |
| FFC 3 | 256 | 256 |
| Concatenation | 32,768 + 256 | 33,024 |

Table 2 above also shows that the output of the frequency domain encoder is 256 nodes (or elements), and that the bottleneck adder 550 between the frequency domain encoder 520 and the decoder 522 concatenates the 256 output elements of the frequency domain encoder 520 with the 32,768 output elements from the time domain encoder 518 to form a single 1D decoder input vector to be input to the decoder 522. It will be understood that other computations may be used to combine the encoder outputs instead, such as element-wise multiplication, addition, subtraction, and so forth.

A Table 3 below shows the subsequent changes in nodes from layer to layer at the decoder 522. The decoder 522 has a generally mirrored structure of three fully connected FC layers relative to the FFC layers of the frequency domain encoder 520. In this case, however, FC layers 4 (552) and 5 (554) do not change the number of elements (here being 33,024), and an FC layer 6 (556) increases the number of elements to 35,547.

TABLE 3
DECODER

| | Dim. In | Dim. Out |
|---|---|---|
| Layer | (nodes) | (nodes) |
| FC 4 | 33,024 | 33,024 |
| FC 5 | 33,024 | 33,024 |
| FC 6 | 33,024 | 35,547 |
| Reshape | 35,547 | 289 × 123 pixels |

A reshape (or reshaping) layer 558 then converts the 1D vector into a 2D surface of pixel coordinates, as assigned to output nodes of the reshape layer 558 for example, and to form localization map data here in the form of amplitude values and represented by the localization map 524. By one form, an output node is provided for each pixel location on the localization map, and by other forms, the output of the reshape layer has less nodes than the number of pixels on the localization map, and the amplitude values of the missing pixel locations may be generated by interpolation. In the continuing example, a localization map of 289 pixels wide by 123 pixels high pixels is provided although other resolutions may be provided instead. The resolution of the localization map depends, at least in part, on head-related transfer functions (HRTFs) available for training as explained below. An HRTF provides a function to generate emulated binaural audio signals when an audio source location relative to a location of a person's ears (or binaural microphones) is known. Also, the reshape layer 558, as with the flatten layers 538 and 540, may or may not be considered a NN layer, and may be considered a separate unit from the NN 500. As mentioned, thereafter, the amplitude values may or may not be normalized, and may or may not be converted to color scheme values to display an image of the localization map 524.

It will be understood that other encoder and decoder architecture can be used instead of that described above, including having varying layers from encoder block to encoder block, and variations in the fully connected layers such as bottleneck layers, dropout layers, or different activation layers.

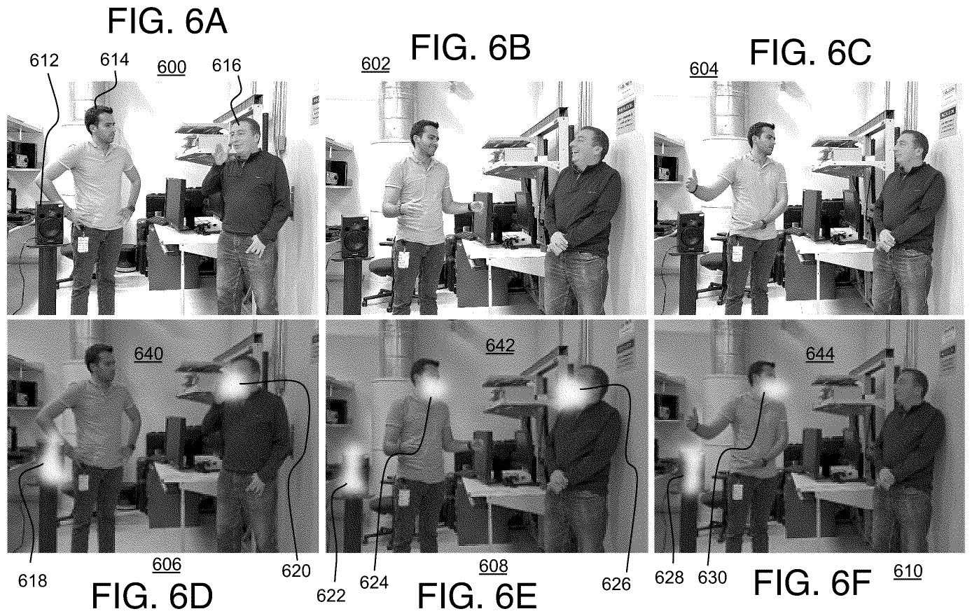

Referring to FIGS. 6A-6F, example results are generated by using the method, system, and devices described above. Images 600, 602, and 604, show three audio sources including a loud speaker 612 and two people 614 and 616 that are active speakers. The audio sources are in all three images 600, 602, and 604. Images 606, 608, and 610 respectively correspond to images 600, 602, and 604 and have a localization map (or map data) 640, 642, 644, which may be an amplitude heat map, superimposed over the images 606, 608, and 610 to accurately show which audio source is emitting sound. Thus, on image 606, the localization map 640 provides bright sound hotspots (or just spots, and here being yellow) 618 and 620 to indicate an audio source location and here to show the speaker 612 and person 616 is emitting sound. Image 608 has localization map 642 that shows the sound spots 622, 624, and 626 to indicate all three audio sources are emitting sound, and image 610 has localization map 644 that shows sound spots 628 and 630 to indicate that speaker 612 and person 614 are emitting sound. Each is an accurate detection of the audio sources.

Further experiments were conducted to show that audio source detection can be performed with a high degree of confidence with the present method and system. For example, to test the effectiveness of the present method and system, a training and testing routine was performed using binaural input audio signals, and to train a NN such as NN 500 (FIG. 5) or NN 122 (FIG. 1) to perform localization map data generation, and as described below.

Specifically, in an example training setup used here, an anechoic chamber has a speaker ring that may be placed over or around an input device position. The speaker ring may have a circular array of speakers, here being 25 speakers in a vertical arrangement although other number of speakers and orientations of the speaker ring may be used. Also, the input device used here was a head and torso simulator (HATS) device that has binaural microphones at inner ear positions on a mannequin with a shape of a human head with ears. Otherwise, a person, or mannequin, wearing a binaural device, such as headphones or earbuds could have been used. The HATS device was placed at the center of the speaker ring and may be moved to specific positions relative to the speaker ring 604. Thus, either the speaker ring may be moved and/or rotated around the input device position, and/or the input device position may be moved relative to the speaker ring.

Referring to FIGS. 7 and 7A, an example audio source map or graph 700 shows a point cloud 702 with audio source location points 704 that may be used by positioning the speaker ring and here around a direction sphere 706 that represents a location of the audio input device, and that audio sources can be placed in any direction from the audio input device. The vertical axis Z of the graph 700 is the elevational direction and the horizontal axis X is the azimuth direction (the graph is in 2D and depth direction Y is not shown). FIG. 7A shows a key of the azimuth and elevational directions.

Ground truth audio source maps were generated for comparison to the localization maps output by the NN and by using the known locations of the training audio sources. Given that azimuth and elevation angles of the direction of the audio source (AoA or AS direction) is known, a publicly available Center for Image and Perceptual Computing (CIPIC) HRTF library set was used to generate ground truth audio signals, which in turn were used to create a ground truth (or here target) localization or target map also referred to as TargetMap. The HRTF audio signals were used to form an all-zero 2D matrix on the target map, and then add a gaussian spot (with the amplitudes in a shape of a 2D gaussian bell curve) in the position of a corresponding azimuth and elevation of an audio source on the target map. The target map then can be used to create a binary mask map to be used in loss function computations, and that replaces the variation of gaussian amplitude values that are included in a location of an audio source with all 1s. The rest of the pixel locations on the mask map are 0s where no audio source is located.

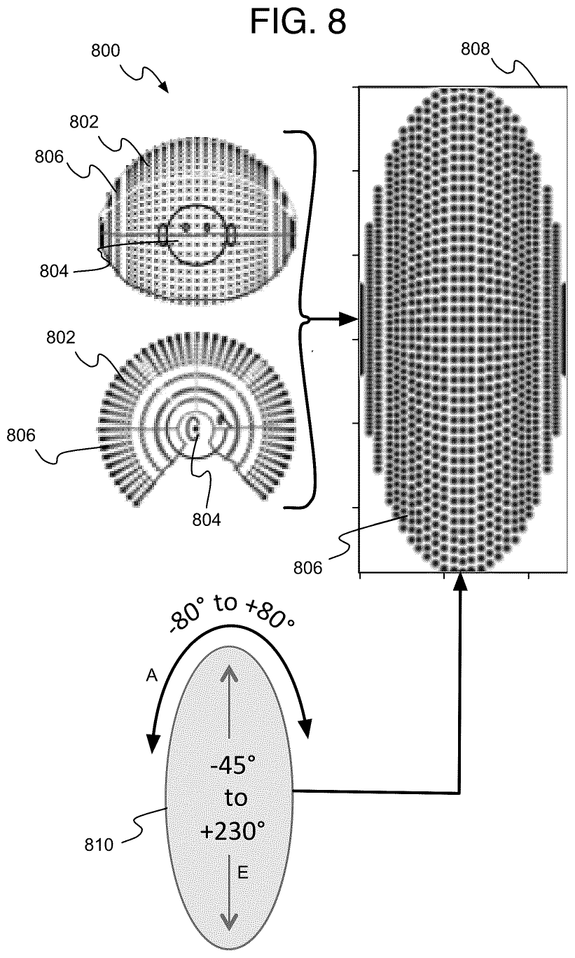

Referring to FIG. 8 for more detail on the audio source locations, an audio source (AS) direction (or AoA) diagram 800 shows the various AS directions that were used during the training. The audio for the training was captured using the speaker ring with the 25 different elevations on a 270° arc that rotates 180° around the person's or HAT's head by rotating the speaker ring, and on 18 azimuth angles (every 10°). This produced 433 total directions to generate binaural audio for the training. An HRTF was used with each direction.

Particularly, a training setup 800 shows a partial sphere 802 of the directions around a person's head 804, and particularly where each point 806 represents one of the 433 directions each mapped with one of the HRTFs. A top pan (or wide angle) view 808 shows all of the points 806 used, and include directions from −45 to +230 degrees in elevation angle and from −80 to +80 degrees in azimuth angle as shown by angle diagram 810. Also as shown, no audio source or AoA directions were provided under the person's head 804 so that less than a full sphere was used for training. Whether directions can be pointed toward the head from under the head 804 may depend on the available HRTFs because not all audio HRTF databases have the audio source directions from under the head. These directions, however, may be obtained by more complicated techniques such as by using a “floating” binaural head (balanced on a minimal base or end of a support frame or rod for example).

An audio source dataset was used to be emitted to render the audio, although it can be more than one audio source dataset, where each audio source was assigned random azimuth and elevation angles as described above with FIGS. 7 and 8. The dataset may include a select number of mono audio signals and may be any desired types of audio such as from audio sources including one or more humans speaking (whether on a same audio source or separate audio sources), and any other sounds such as a vehicle horns, traffic, dog barking, musical instruments, baby crying, animal noises, and so forth. Such audio is often provided in audio datasets such as TIMIT, or Audioset.

Then, the audio sources were rendered from their assigned location, and specifically assigned direction. The directions mentioned above (433 directions (25 different elevation angles and 18 azimuth angles) were established by positioning the speaker ring in the corresponding audio source location relative to the head or HATS being used as explained above.

To train on the data of multiple simultaneous audio sources, the samples of the 433 directions were mixed to obtain multi-source samples. Thus, by one example, either multiple audio sources were used in a single emission time period, or the individual samples were mixed together by channel-wise combination of their filtered signals. This was applied randomly in both direction and distance to replicate the real scenarios when multiple sounds are heard simultaneously, such as when a pet, refrigerator, and television are emitting audio to name one random example. By one example, three sources were mixed, but other numbers of audio sources may be used instead such as 1 to 4.

The audio is captured using the binaural microphones. As mentioned, a HATS device may be used rather than a person sitting wearing a binaural audio input device such as headphones or earbuds to pick up the rendered audio. This operation also then may include using HRTF computations to generate the target or ground truth binaural audio signals from the HATS device as explained above. Impulse responses from the audio sources, here from the 433 directions of varying angles around the HATS, were then captured (and measured) by generating frequencies of the audio signals that can be shown in spectrograms for example, as well as signal magnitudes.

A total of 13,028 audio segments of 5 second duration at 44.1 kHz of sample frequency were collected. These audio sources were used to generate binaural audio, comprising a partial sphere around the head (as in FIGS. 4 and 7), during neural network training. Of all the generated segments, 80% were used for training and the rest (20%, 2,605 samples) were used for validation. The random combination of different audio sources and directions better assures every sample generated is unique.

Next, the audios samples were input into the NN to generate localization map data. As mentioned in the examples above, the NN inputs both time and frequency domain versions of the audio samples into encoders. This may involve placing 1D frequency and time domain vectors into NN input buffers (or having the buffers accessible) that provide the input of the first layer (or flatten layer or unit for frequency vectors) of the NN. This also may involve placing the input values of the surfaces into MAC registers when accelerators are used. Many variations are contemplated.

Once localization map data is output by the NN, the training process than may compute a loss by using a loss function that maximizes true positive and true negative error in order to minimize the total loss. This is accomplished by comparing NN generated predicted localization maps to ground truth localization maps. Specifically, the loss function for this training was a weight-mean absolute error between a predicted heat map and a ground truth map represented by the binary mask or mask map rather than the actual TargetMap. As mentioned above, the mask (mask map) is different than the TargetMap in that the mask only has is for the audio source locations, and 0s everywhere else, rather than varying amplitude values as with a Gaussian curve as on the TargetMap. The operations to compute the loss function may be as follows:

(A) Compute the error:

$$error = TargetMap - PredictedMap \qquad ( 1 )$$

where TargetMap is a ground truth map, and the PredictMap is the map generated by the NN. The values of the maps are amplitude values that may be in a range of 0 to 255 (for 8-bit calculations), and that may be normalized from 0 to 1. The subtraction creates a 2D error surface with an error per pixel coordinate location. The error may have a range of 0 to 255 (for 8-bit calculations), or 0 to 1 when the amplitude values are normalized. When the amplitude values are normalized, 0 on the 2D error surface refers to no error (0 error), and 1 is the maximum error.

(B) Subtract the error from 1 (good=1−error) and this is again performed pixel by pixel and to generate a good map with what was predicted from the NN as an audio source position. Thus, the worst prediction will have a good map (or good prediction map) of all 0s, and the best possible prediction will have a good prediction map of all is.

(C) Compute a true positive determination or percentage:

$$( tp = sum ( good * mask ) / sum ( mask ) ) \qquad ( 2 )$$

where the * refers to element-by-element multiplication of corresponding elements from the good map and the mask map. The sum is a sum of all multiplication products (or elements on the lower term).

(D) Compute a true negative determination or percentage:

$$( tn = sum ( good * ( 1 - mask ) ) / sum ( 1 - mask ) ) \qquad ( 3 )$$

Since the audio source location on the mask is also is, the maximum value for both tp and tn is one.

(5) Compute loss as:

$$LOSS = 1 - mean ( tp * tn ) \qquad ( 4 )$$

This equation attempts to maximize the percentage of tp and tn as much as possible with equal importance, although a weight could be applied to either or both of the tp and tn to emphasize one or the other.

The training is then run until the NN loss function (eq. (4)) is minimized. Thus, the neural network may be run until the loss function achieves a stationary state (convergence or it has stopped decreasing in value), or a certain number of epochs have been reached. Once minimized, the hyper parameters (weights, bias, etc.) for the NN are set for sufficiently accurate localization map data generation.

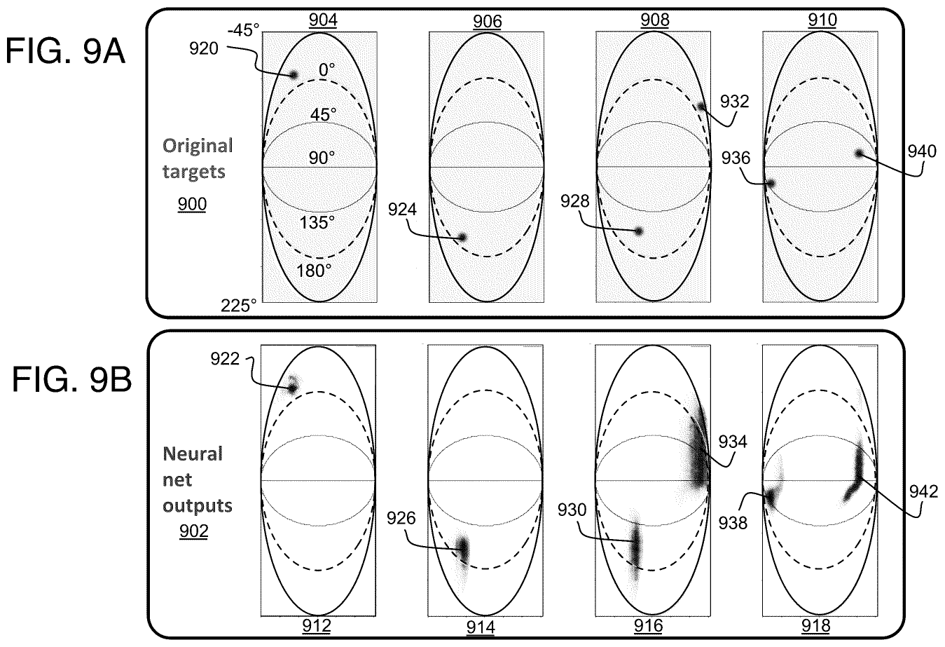

Referring to FIGS. 9A-9B for the training and testing results, a set 900 of original target (or ground truth) localization maps 904, 906, 908, and 910 correspond respectively to NN generated localization maps 912, 914, 916, and 918 in a set 902 of predicted localization maps. Each map represents azimuth angles along the horizontal dimension of the map from left-to-right of 0 to 120 degrees, while the vertical dimension represents elevational angles as shown by the upper and lower ends of each ring including the top and bottom of an outer solid ring, a middle dashed ring (and a line through the middle of the map), and an inner light ring that represents, from bottom to top of the maps, 225 deg., 180 deg, 135 deg, 90 deg, 45 deg. 0 deg., and −45 deg. See map 904 for example. It can be seen that each NN output map of set 902 has the sound location (or audio source) very close to the position of the source on its corresponding target map of set 900. Thus, target audio source locations 920, 924, 928, 932, 936, and 940 respectively correspond to output locations 922, 926, 930, 934, 938, and 942. Despite a blur on the localization maps, this still indicates at least correct a general area or audio source location. In a centroid-based analysis, the mean absolute angle detection error was estimated to be around about 10°, and depending on the application, was found to be sufficiently accurate.

While implementation of the example processes 200 as well as systems or networks 100, 300, 400, 500, 1000, 1100, and 1200 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions of the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality. Other than the term “logic unit”, the term “unit” refers to any one or combination of software logic, firmware logic, hardware logic, and/or circuitry configured to provide the functionality described herein.

As used in any implementation described herein, the term “component” may refer to a module, unit, or logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, and processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

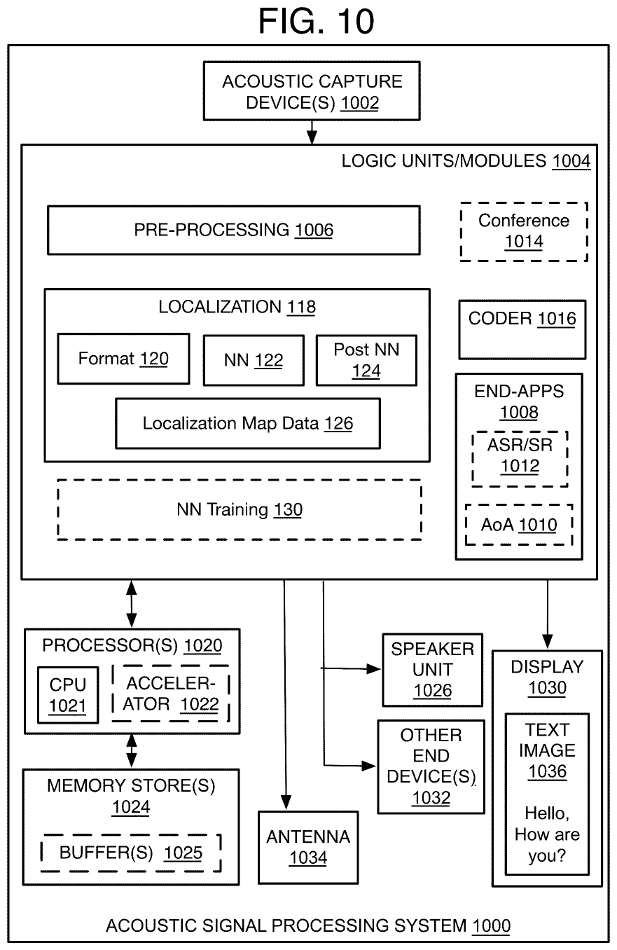

Referring to FIG. 10, an example acoustic signal processing system 1000 is arranged in accordance with at least some implementations of the present disclosure. In various implementations, the example acoustic signal processing system 1000 may have acoustic capture devices 1002, such as listening or input devices with binaural microphones (or other types of microphones, or no microphones when system 1000 is not used as a binaural input device) as described herein. One or more microphones are present to receive acoustic waves and form acoustical signal data. This can be implemented in various ways. Thus, in one form, the acoustic signal processing system 1000 is one of the listening devices, and has binaural microphones. In other examples, the acoustic signal processing system 1000 may be in communication with one or more listening devices 1002 with binaural microphones to be used for localization, and may or may not have its own microphones of any type. Thus, the system 1000 may be remote from these acoustic signal capture devices 1002 such that logic modules 1004 may communicate remotely with, or otherwise may be communicatively coupled to, the microphones for further processing of the acoustic data.

In either case, such technology may include a smart phone, smart speaker, a tablet, laptop or other computer, video or phone conference console, dictation machine, other sound recording machine, a mobile device or an on-board device, or any combination of these. Thus, in one form, audio capture devices 1002 may include audio capture hardware including one or more sensors (e.g., microphone or audio capture components) as well as actuator controls. These controls may be part of a sensor module or component for operating the sensor. The sensor component may be part of the audio capture device 1002, or may be part of the logical modules 1004 or both. Such sensor component can be used to convert sound waves into an electrical acoustic signal. The audio capture device 1002 also may have its own pre-processing units such as an A/D converter, AEC unit, other filters, and so forth to provide a digital signal for acoustic signal processing.

In the illustrated example, the logic units and modules 1004 may include a pre-processing unit 1006, a localization unit 118, and optionally a NN training unit 130 when device or system 1000 is also used for training. The localization unit 118 may have a NN format unit 120, a NN 122, a post NN unit 124, a localization map data unit 126, as well as other units, and as already described above with FIG. 1.

For transmission and emission of the audio, the system 1000 may have a coder unit 1016 for encoding and an antenna 1034 for transmission to a remote output device, as well as a speaker 1026 for local emission. When the logic modules 1004 are on a host device for a phone conference for example, the logic modules 1004 also may include a conference unit 1014 to host and operate a video or phone conference system as mentioned herein.

The logic modules 1004 also may include an end-apps unit 1008 to perform further audio processing such as with an ASR/SR unit 1012, an AoA unit 1010, a beam-forming unit, and/or other end applications that may be provided to analyze and otherwise use the localization map data. The logic modules 1004 also may include other end devices 1032, which may include a transmission decoder to decode input signals when audio is received via transmission, and if not already provided with coder unit 1016. These units may be used to perform the operations described above where relevant. The tasks performed by these units or components are indicated by their labels and may perform similar tasks as those units with similar labels as described above.

The acoustic signal processing system 1000 may have processor circuitry 1020 forming one or more processors which may include central processing unit (CPU) 1021 and/or one or more dedicated accelerators 1022 such as with the Intel Atom, memory stores 1024 with one or more buffers 1025 to hold audio-related data such as samples, frames, NN vectors, NN input data, intermediate NN data from any NN layer, NN output localization map data, NN hyper-parameters, any NN training data, and so forth as described above, at least one speaker unit 1026 to emit audio based on the input audio signals, or responses thereto, when desired, one or more displays 1030 to provide images 1036 of text for example, as a visual response to the acoustic signals if such is used. The other end device(s) 1032 also may perform actions in response to the acoustic signal. In one example implementation, the acoustic signal processing system 1000 may have the at least one processor of the processor circuitry 1020 communicatively coupled to the acoustic capture device(s) 1002 (such as at least two microphones) and at least one memory 1024. As illustrated, any of these components may be capable of communication with one another and/or communication with portions of logic modules 1004 and/or audio capture device 1002. Thus, processors of processor circuitry 1020 may be communicatively coupled to the audio capture device 1002, the logic modules 1004, and the memory 1024 for operating those components.

While typically the label of the units or blocks on device 1000 at least indicates which functions are performed by that unit, a unit may perform additional functions or a mix of functions that are not all suggested by the unit label. Also, although acoustic signal processing system 1000, as shown in FIG. 10, may include one particular set of units or actions associated with particular components or modules, these units or actions may be associated with different components or modules than the particular component or module illustrated here,

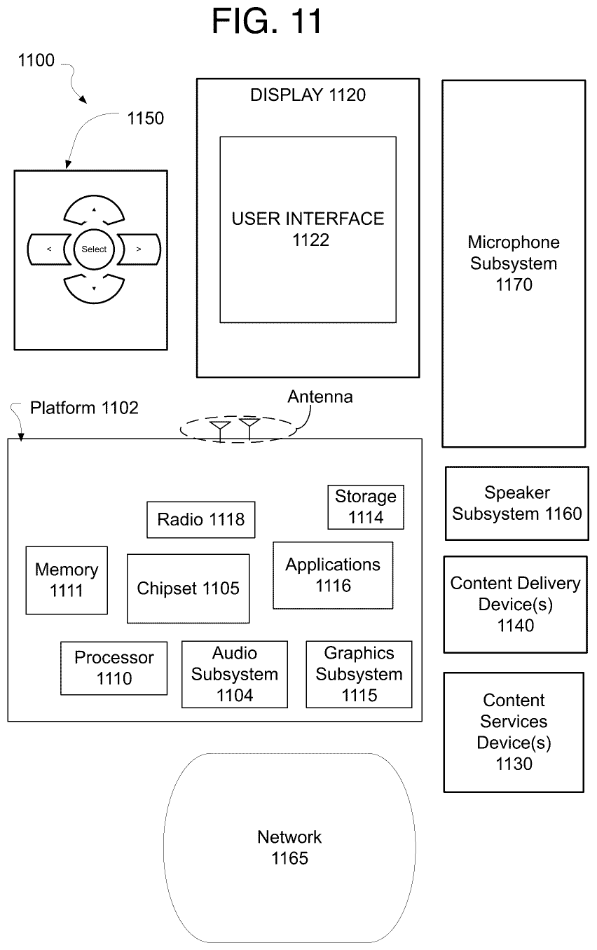

Referring to FIG. 11, an example system 1100 in accordance with the present disclosure operates one or more aspects of the speech processing system described herein. It will be understood from the nature of the system components described below that such components may be associated with, or used to operate, certain part or parts of the speech processing system described above. In various implementations, system 1100 may be a media system although system 1100 is not limited to this context. For example, system 1100 may be incorporated into multiple microphones of a network of microphones on listening devices, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth, but otherwise any device that can provide one or more of the microphones, the audio signals from the microphones, the localization map data, and/or the training unit to train the localization NN.

In various implementations, system 1100 includes a platform 1102 coupled to a display 1120. Platform 1102 may receive content from a content device such as content services device(s) 1130 or content delivery device(s) 1140 or other similar content sources. A navigation controller 1150 including one or more navigation features may be used to interact with, for example, platform 1102, speaker subsystem 1160, microphone subsystem 1170, and/or display 1120. Each of these components is described in greater detail below.

In various implementations, platform 1102 may include any combination of a chipset 1105, processor 1110, memory 1111 storage 1114, audio subsystem 1104, graphics subsystem 1115, applications 1116 and/or radio 1118. Chipset 1105 may provide intercommunication among processor 1110, memory 1111, storage 1114, audio subsystem 1104, graphics subsystem 1115, applications 1116 and/or radio 1118. For example, chipset 1105 may include a storage adapter (not depicted) capable of providing intercommunication with storage 1114. Either audio subsystem 1104 or the microphone subsystem 1170 may have any of the units related to localization map data generation described above.

Processor 1110 may be implemented as a Complex Instruction Set Computer (CISC) or Reduced Instruction Set Computer (RISC) processors; ×86 instruction set compatible processors, multi-core, or any other microprocessor or central processing unit (CPU). In various implementations, processor 1110 may be dual-core processor(s), dual-core mobile processor(s), and so forth.

Memory 1111 may be implemented as a volatile memory device such as, but not limited to, a Random Access Memory (RAM), Dynamic Random Access Memory (DRAM), or Static RAM (SRAM).

Storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1114 may include technology to increase the storage performance enhanced protection for valuable digital media when multiple hard drives are included, for example.

Audio subsystem 1104 may perform processing of audio such as acoustic signals for one or more audio-based applications such as localization map data generation as described herein, and/or other audio processing applications such as speech recognition, speaker recognition, and so forth. The audio subsystem 1104 may have audio conference (or the audio part of video conference) hosting modules. The audio subsystem 1104 may comprise one or more processing units, memories, and accelerators. Such an audio subsystem may be integrated into processor 1110 or chipset 1105. In some implementations, the audio subsystem 1104 may be a stand-alone card communicatively coupled to chipset 1105. An interface may be used to communicatively couple the audio subsystem 1104 to a speaker subsystem 1160, microphone subsystem 1170, and/or display 1120.

Graphics subsystem 1115 may perform processing of images such as still or video for display. Graphics subsystem 1115 may be a graphics processing unit (GPU) or a visual processing unit (VPU), for example. An analog or digital interface may be used to communicatively couple graphics subsystem 1115 and display 1120. For example, the interface may be any of a High-Definition Multimedia Interface, Display Port, wireless HDMI, and/or wireless HD compliant techniques. Graphics subsystem 1115 may be integrated into processor 1110 or chipset 1105. In some implementations, graphics subsystem 1115 may be a stand-alone card communicatively coupled to chipset 1105.

The audio processing techniques described herein may be implemented in various hardware architectures. For example, audio functionality may be integrated within a chipset. Alternatively, a discrete audio processor may be used. As still another implementation, the audio functions may be provided by a general purpose processor, including a multi-core processor. In further implementations, the functions may be implemented in a consumer electronics device.

Radio 1118 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In various implementations, display 1120 may include any television type monitor or display. Display 1120 may include, for example, a computer display screen, touch screen display, video monitor, television-like device, and/or a television. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, platform 1102 may display user interface 1122 on display 1120.

In various implementations, content services device(s) 1130 may be hosted by any national, international and/or independent service and thus accessible to platform 1102 via the Internet, for example. Content services device(s) 1130 may be coupled to platform 1102 and/or to display 1120, speaker subsystem 1160, and microphone subsystem 1170. Platform 1102 and/or content services device(s) 1130 may be coupled to a network 1165 to communicate (e.g., send and/or receive) media information to and from network 1165. Content delivery device(s) 1140 also may be coupled to platform 1102, speaker subsystem 1160, microphone subsystem 1170, and/or to display 1120.

In various implementations, content services device(s) 1130 may include a network of microphones, a cable television box, personal computer, network, telephone, Internet enabled devices or appliance capable of delivering digital information and/or content, and any other similar device capable of unidirectionally or bidirectionally communicating content between content providers and platform 1102 and speaker subsystem 1160, microphone subsystem 1170, and/or display 1120, via network 1165 or directly. It will be appreciated that the content may be communicated unidirectionally and/or bidirectionally to and from any one of the components in system 1100 and a content provider via network 1165. Examples of content may include any media information including, for example, video, music, medical and gaming information, and so forth.

Content services device(s) 1130 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1102 may receive control signals from navigation controller 1150 having one or more navigation features. The navigation features of controller 1150 may be used to interact with user interface 1122, for example. In implementations, navigation controller 1150 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 1104 also may be used to control the motion of articles or selection of commands on the interface 1122.

Movements of the navigation features of controller 1150 may be replicated on a display (e.g., display 1120) by movements of a pointer, cursor, focus ring, or other visual indicators displayed on the display or by audio commands. For example, under the control of software applications 1116, the navigation features located on navigation controller 1150 may be mapped to virtual navigation features displayed on user interface 1122, for example. In implementations, controller 1150 may not be a separate component but may be integrated into platform 1102, speaker subsystem 1160, microphone subsystem 1170, and/or display 1120. The present disclosure, however, is not limited to the elements or in the context shown or described herein.

In various implementations, drivers (not shown) may include technology to enable users to instantly turn on and off platform 1102 like a television with the touch of a button after initial boot-up, when enabled, for example, or by auditory command. Program logic may allow platform 1102 to stream content to media adaptors or other content services device(s) 1130 or content delivery device(s) 1140 even when the platform is turned “off.” In addition, chipset 1105 may include hardware and/or software support for 8.1 surround sound audio and/or high definition (7.1) surround sound audio, for example. Drivers may include an auditory or graphics driver for integrated auditory or graphics platforms. In implementations, the auditory or graphics driver may comprise a peripheral component interconnect (PCI) Express graphics card.

In various implementations, any one or more of the components shown in system 1100 may be integrated. For example, platform 1102 and content services device(s) 1130 may be integrated, or platform 1102 and content delivery device(s) 1140 may be integrated, or platform 1102, content services device(s) 1130, and content delivery device(s) 1140 may be integrated, for example. In various implementations, platform 1102, audio subsystem 1104, speaker subsystem 1160, and/or microphone subsystem 1170 may be an integrated unit. Display 1120, speaker subsystem 1160, and/or microphone subsystem 1170 and content service device(s) 1130 may be integrated, or display 1120, speaker subsystem 1160, and/or microphone subsystem 1170 and content delivery device(s) 1140 may be integrated, for example. These examples are not meant to limit the present disclosure.

In various implementations, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1102 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, text message, any social website messaging, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 11.

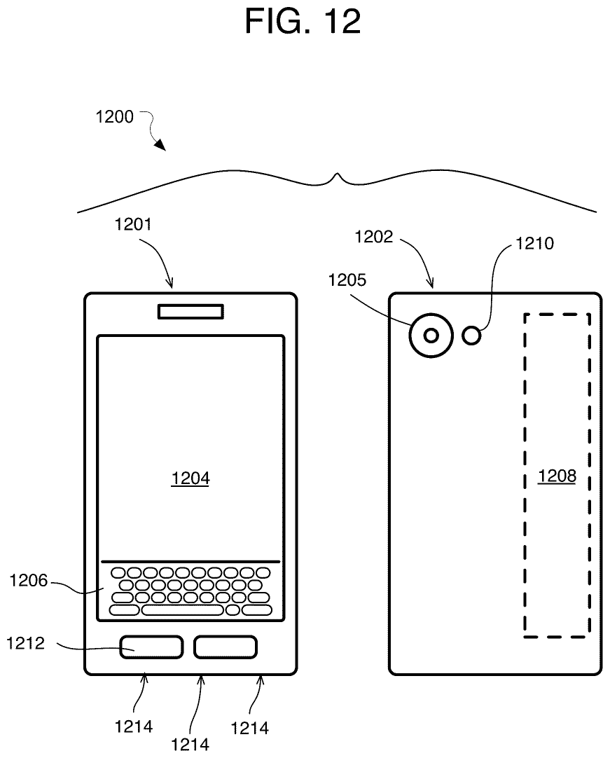

Referring to FIG. 12, a small form factor device 1200 is one example of the varying physical styles or form factors in which systems 1000 or 1100 may be embodied. By this approach, device 1200 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system such as a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, smart speaker, or smart television), mobile internet device (MID), messaging device, data communication device, speaker system, microphone system or network, and so forth, and any other on-board (such as on a vehicle), or building, computer that may accept audio commands.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 12, device 1200 may include a housing with a front 1201 and a back 1202. Device 1200 includes a display 1204, an input/output (I/O) device 1206, and an integrated antenna 1208. Device 1200 also may include navigation features 1212. I/O device 1206 may include any suitable I/O device for entering information into a mobile computing device. Examples for I/O device 1206 may include an alphanumeric keyboard, a numeric keypad, a touch pad, input keys, buttons, switches, microphones, speakers, voice recognition device and software, and so forth. Information also may be entered into device 1200 by way of one or more microphones 1214 that may be part of a linear microphone array or other shape of microphone array. As shown, device 1200 may include a camera 1205 (e.g., including a lens, an aperture, and an imaging sensor) and a flash 1210 integrated into back 1202, front 1201, or elsewhere of device 1200.

Various implementations may be implemented using hardware elements, software elements, or a combination of both. Examples of hardware elements may include processor circuitry forming processors and/or microprocessors, as well as circuits, circuit elements (e.g., transistors, resistors, capacitors, inductors, and so forth), integrated circuits, application specific integrated circuits (ASIC), programmable logic devices (PLD), digital signal processors (DSP), fixed function hardware, field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

In example 1, a computer-implemented method of audio processing comprises receiving, by processor circuitry, binaural audio signals at least overlapping at a same time and of a same two or more audio sources; and generating localization map data indicating locations of the two or more audio sources relative to microphones providing the binaural audio signals and comprising inputting at least one version of the binaural audio signals into at least one neural network (NN).

In example 2, the subject matter of example 1, wherein the inputting comprises inputting both time domain and frequency domain versions of the binaural audio signals into the NN.

In example 3, the subject matter of example 1 or 2, wherein the at least one version of the binaural audio signals are the only audio signals input to the NN.

In example 4, the subject matter of any one of examples 1 to 3, wherein the NN comprises a time domain encoder, a frequency domain encoder, and a decoder, and wherein the method comprises combining output of the time domain encoder and the frequency domain encoder to generate input of the decoder.

In example 5, the subject matter of any one of examples 1 to 4, wherein the combining comprises concatenating a vector of output values of the time domain encoder with a vector of output values of the frequency domain encoder.

In example 6, the subject matter of any one of examples 1 to 5, wherein the NN comprises a time domain encoder comprising a sequence of convolutional encoder blocks.

In example 7, the subject matter of example 6, wherein multiple one of the encoder blocks each comprise, in propagation order, a first convolution layer, a rectified linear unit (ReLU) layer, a second convolutional layer, and a gated linear unit (GLU) layer.

In example 8, the subject matter of any one of examples 1 to 7, wherein the NN comprises a frequency domain encoder comprising a series of fully connected layers.

In example 9, the subject matter of any one of examples 1 to 8, wherein the NN comprises a decoder comprising a series of fully connected layers.

In example 10, the subject matter of any one of examples 1 to 9, wherein the NN is trained, at least in part, by using at least two overlapping audio sources.

In example 11, at least one non-transitory computer readable medium comprises a plurality of instructions that in response to being executed on a computing device, causes the computing device to operate by: receiving, by processor circuitry, binaural audio signals at least overlapping at a same time and of a same two or more audio sources; and training a neural network (NN) comprising inputting at least one version of the binaural audio signals into the NN, outputting output localization map data indicating locations of the two or more audio sources relative to microphones providing the binaural audio signals, and comparing a version of the output localization map data to a version of ground truth localization map data.

In example 12, the subject matter of example 11, wherein the training comprises generating binaural audio signals with audio of simultaneous audio sources each at different randomly selected angles relative to a location of the microphones.

In example 13, the subject matter of example 11 or 12, wherein the training comprises minimizing a loss that is a difference between a version of the output localization map data and a version of ground truth localization map data, and by using both true positive and true negative determinations.

In example 14, the subject matter of any one of examples 11 to 13, wherein the training comprises minimizing a loss comprising using binary mask map data as ground truth localization map data.

In example 15, a computer-implemented system, comprises memory to hold binaural audio signals, wherein the binaural audio signals at least overlap in time and are associated with a same at least two audio sources; and processor circuitry communicatively connected to the memory, the processor circuitry being arranged to operate by: generating localization map data indicating locations of the at least two audio sources relative to microphones providing the binaural audio signals and comprising inputting at least one version of the binaural audio signals into at least one neural network (NN).

In example 16, the subject matter of example 15, wherein the localization map data provides data for a location of the at least two audio sources being in any direction relative to a location of the microphones.

In example 17, the subject matter of example 15 or 16, wherein the localization map data is output from the neural network and comprises audio signal amplitude values, and wherein the processor circuitry is arranged to operate by converting the amplitude values into color pixel values of a heat map.

In example 18, the subject matter of any one of examples 15 to 17, wherein the microphones are on headphones, a headset, earbuds, eyewear, or glasses comprising microphones arranged to be held within at most 3 inches from an opening of an ear canal.

In example 19, the subject matter of any one of examples 15 to 18, wherein the neural network comprises a time domain encoder comprising a prior layer disposed before a time flattening layer, a frequency domain encoder with a frequency flattening layer disposed before a series of frequency fully connected layers, and a decoder with a series of decoder fully connected layers before a reshaping layer, wherein the time flattening layer converts 2D surfaces of the prior layer into a single time vector to be output of the time domain encoder, wherein the frequency flattening layer converts two input channels of a version of the binaural audio signals into a single frequency vector to be input to the series of frequency fully connected layers to output a single frequency vector from the frequency domain encoder, wherein the single time vector and single frequency vector are combined to form input of the decoder, and wherein the reshaping layer converts a vector from the series of decoder fully connected layers into a 2D surface of the localization map data.

In example 20, the subject matter of any one of examples 15 to 19, wherein locations of audio sources on the localization map data have an average error of ten degrees.

In example 21, a device or system includes a memory and processor circuitry to perform a method according to any one of the above examples.

In example 22, at least one machine readable medium includes a plurality of instructions that in response to being executed on a computing device, cause the computing device to perform a method according to any one of the above examples.

In example 23, an apparatus may include means for performing a method according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of audio processing, comprising:
receiving, by processor circuitry, binaural audio signals at least overlapping at a same time and of a same two or more audio sources; and
generating localization map data indicating locations of the two or more audio sources relative to microphones providing the binaural audio signals and comprising inputting at least one version of the binaural audio signals into at least one neural network (NN).

2. The method of claim 1, wherein the inputting comprises inputting both time domain and frequency domain versions of the binaural audio signals into the NN.

3. The method of claim 1, wherein the at least one version of the binaural audio signals are the only audio signals input to the NN.

4. The method of claim 1, wherein the NN comprises a time domain encoder, a frequency domain encoder, and a decoder, and the method comprising combining output of the time domain encoder and the frequency domain encoder to generate input of the decoder.

5. The method of claim 4, wherein the combining comprises concatenating a vector of output values of the time domain encoder with a vector of output values of the frequency domain encoder.

6. The method of claim 1, wherein the NN comprises a time domain encoder comprising a sequence of convolutional encoder blocks.

7. The method of claim 6, wherein multiple one of the encoder blocks each comprise, in propagation order, a first convolution layer, a rectified linear unit (ReLU) layer, a second convolutional layer, and a gated linear unit (GLU) layer.

8. The method of claim 1, wherein the NN comprises a frequency domain encoder comprising a series of fully connected layers.

9. The method of claim 1, wherein the NN comprises a decoder comprising a series of fully connected layers.

10. The method of claim 1, wherein the NN is trained by using at least two overlapping audio sources.

11. At least one non-transitory computer readable medium comprising a plurality of instructions that in response to being executed on a computing device, causes the computing device to operate by:
receiving, by processor circuitry, binaural audio signals at least overlapping at a same time and of a same two or more audio sources; and
training a neural network (NN) comprising inputting at least one version of the binaural audio signals into the NN, outputting output localization map data indicating locations of the two or more audio sources relative to microphones providing the binaural audio signals, and comparing a version of the output localization map data to a version of ground truth localization map data.

12. The medium of claim 11, wherein the training comprises generating binaural audio signals with audio of simultaneous audio sources each at different randomly selected angles relative to a location of the microphones.

13. The medium of claim 11, wherein the training comprises minimizing a loss that is a difference between a version of the output localization map data and a version of ground truth localization map data, and by using both true positive and true negative determinations.

14. The medium of claim 11, wherein the training comprises minimizing a loss comprising using binary mask map data as ground truth localization map data.

15. A computer-implemented system, comprising:
memory to hold binaural audio signals, wherein the binaural audio signals at least overlap in time and are associated with a same at least two audio sources; and
processor circuitry communicatively connected to the memory, the processor circuitry being arranged to operate by:
generating localization map data indicating locations of the at least two audio sources relative to microphones providing the binaural audio signals and comprising inputting at least one version of the binaural audio signals into at least one neural network (NN).

16. The system of claim 15, wherein the localization map data provides data for a location of the at least two audio sources being in any direction relative to a location of the microphones.

17. The system of claim 15, wherein the localization map data is output from the neural network and comprises audio signal amplitude values, and wherein the processor circuitry is arranged to operate by converting the amplitude values into color pixel values of a heat map.

18. The system of claim 15, wherein the microphones are on headphones, a headset, earbuds, eyewear, or glasses comprising microphones arranged to be held within at most 3 inches from an opening of an ear canal.

19. The system of claim 15, wherein the neural network comprises a time domain encoder comprising a prior layer disposed before a time flattening layer, a frequency domain encoder with a frequency flattening layer disposed before a series of frequency fully connected layers, and a decoder with a series of decoder fully connected layers before a reshaping layer,
wherein the time flattening layer converts 2D surfaces of the prior layer into a single time vector to be output of the time domain encoder,
wherein the frequency flattening layer converts two input channels of a version of the binaural audio signals into a single frequency vector to be input to the series of frequency fully connected layers to output a single frequency vector from the frequency domain encoder,
wherein the single time vector and single frequency vector are combined to form input of the decoder, and
wherein the reshaping layer converts a vector from the series of decoder fully connected layers into a 2D surface of the localization map data.

20. The system of claim 15, wherein locations of audio sources on the localization map data have an average error of ten degrees.
